(19) United States
(12) Patent Application Publication
(10) Pub. No.: US 2011/0146569 A1
(43) Pub. Date: Jun. 23, 2011

(54) Apparatus for Deposition of Lacquer Overspray

(75) Inventors: Jan Reichler, Konstanz (DE); Werner Swoboda, Boeblingen (DE)

(73) Assignee: EISENMANN AG, Boeblingen (DE)

(21) Appl. No.: 13/060,797

(22) PCT Filed: Aug. 13, 2009
(86) PCT No.: PCT/EP09/05864

§ 371 Date: Feb. 25, 2011

(30) Foreign Application Priority Data
Sep. 4, 2008 (DE) 10 2008 046 411.2

(51) Int. Cl. B05B 15/00

(52) U.S. Cl. 118/620

(57) ABSTRACT

An apparatus for deposition of lacquer overspray from the used cabin air of painting facilities laden with overspray comprises electrode apparatus and/or several regions of an electrode apparatus allocated to several different deposition surfaces. The several electrode apparatus and/or regions of one and the same electrode apparatus can be charged with high voltage independently of each other. This achieves not only an energy savings but also fault locating in the high voltage range is simplified and emergency operation in case of a breakdown in the high-voltage range is made possible.

The invention relates to an apparatus for deposition of lacquer overspray from the used booth air of painting facilities laden with overspray, comprising
a) at least one separation surface, along which the used booth air can be guided and which is connected in an electrically conductive manner to a pole of a high-voltage source;
b) at least one electrode means arranged in the air stream, which is associated with the separation surface and which is connected to the other pole of the high-voltage source;

When paints are applied manually or automatically to articles, a portion of the stream of paint, which in general contains both solids and solvents and/or binders, is not applied to the article. This portion of the stream is called “overspray” among experts. The overspray is taken up by the air stream in the spray booth and fed to a separation process.

In particular in the case of systems having a relatively high paint consumption, for example systems for painting vehicle bodies, wet separation systems are preferably used. In commercially known wet separators, water flows together with the used booth air coming from above to a nozzle that accelerates the flow of air. In this nozzle, the used booth air which flows through is swirled with the water. During this procedure, the overspray particles are substantially transferred to the water, with the result that the air leaves the wet separator substantially cleaned, and the particles of paint overspray are in the water. Said particles can then be recovered therefrom or disposed of.

In the case of known wet separators, relatively large amounts of energy are needed to circulate the quite considerable quantities of water required. Because of the heavy use of paint-binding and adhesive-removing chemicals and because of the disposal of paint sludge, preparing the rinsing water is cost-intensive. Furthermore, the air takes up a very considerable amount of moisture as a result of its intensive contact with the rinsing water, and this in turn results in high energy consumption for the preparation of air in the air circulation mode.

In contrast, in the case of commercially known devices of the type mentioned in the introduction, separation is carried out in dry conditions, in that particles of paint overspray which are carried along by the used booth air which flows past are ionised by the electrode means and, because of the electrical field that is formed between the separation surface and the electrode means, migrate to the separation surface and are separated off there.

The particles of paint overspray which adhere to the separation surface can then, for example, be stripped mechanically therefrom and transported away.

In these known devices, all electrode means are supplied at the same time from one and the same high voltage source. If a fault occurs in the high voltage range, locating the error is relatively complicated; undesirably long stoppage times of the device may occur. In the event of a fault, the entire high voltage system has to be switched off, so that an active filtering process is no longer carried out in the entire device.

It is the object of the present invention to develop a device of the aforementioned type so that locating faults is simplified, where faults occur in the high voltage range, and the stoppage times of the entire device are reduced in this manner.

This object is achieved according to the invention in that

c) a plurality of electrode means and/or a plurality of regions of an electrode means allocated to different separation surfaces are provided, which may be charged with high voltage independently of one another.

If in the device configured according to the invention a breakdown occurs in the high voltage range, the electrode means and/or the respective region of the electrode means where the fault is located may be easily established and then switched off. The entire device in this case does not need to be brought to a standstill, but may continue to be operated in emergency mode, which still permits sufficient separation of the paint overspray. A desired secondary effect of this type, to be able to supply different electrode means and/or different regions of the same electrode means independently with high voltage, is that the electrode means and/or the regions of the electrode means which are not currently required may be switched off, as a result of which a not inconsiderable energy saving is achieved.

A first option for charging the electrode means and/or the plurality of regions of one and the same electrode means with high voltage independently of one another is that said electrode means and/or regions may be connected to one and the same high voltage source. In this case, therefore, only one single high voltage source is required. Appropriate contactors may be used as switching devices.

A slightly more costly way of independent impingement with high voltage is that a separate high voltage source is assigned to each of the plurality of electrode means and/or each of the plurality of regions of the one electrode means. In this manner, for a slightly greater equipment cost, the possibility of emergency operation is obtained even in the case of where a fault occurs in the region of a high voltage source. The other electrode means and/or the other regions of the electrode means may thus still continue to be operated by the high voltage source assigned thereto. Moreover, in this embodiment the capacities are smaller; and the electrical charge created in the event of flashover is lower.

In terms of energy use, it is expedient if at least one electrode means comprises a plurality of corona wires and a planar, preferably flat, field electrode as regions able to be charged independently with high voltage. The ionisation of the overspray particles takes place in the region of the corona wires, whilst the separation of the overspray particles at the separation surfaces substantially takes place in the field of the planar field electrode.

Thus, once again it is particularly advantageous if a plurality of corona wires are subdivided into a plurality of groups, each group being a region of the electrode means which may be charged independently with high voltage. In this case, not only the desired redundancy is obtained in the event of a fault occurring in the high voltage range, but also the possibility of charging the different groups of corona wires with different levels of high voltages. The highest voltage is generally applied to that group of corona wires which is furthest away from the planar field electrode.

The subdivision of the corona wires into a plurality of groups also has the advantage that the individual groups may be activated in a cyclical manner. This is also associated to a certain extent with energy saving. Additionally, the cyclical switching-on of the different regions of the electrode means has the advantage that the adhesion of the overspray particles at the separation surface is reduced in the region opposing the corona wire, where this is not desired.

Exemplary embodiments of the invention are described in more detail below with reference to the drawings, in which:

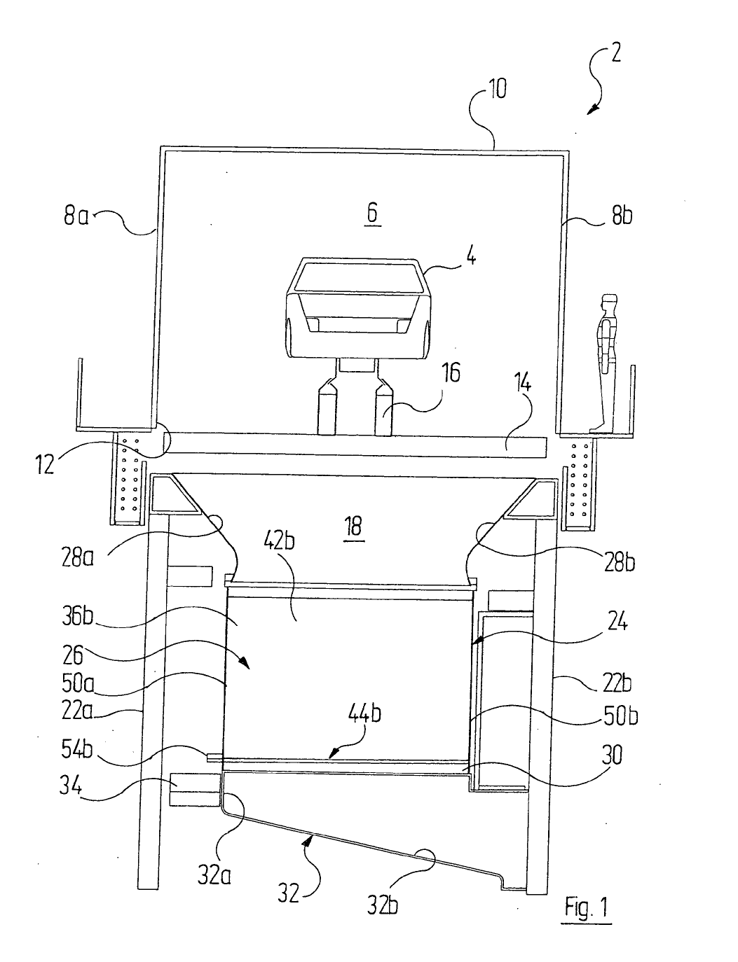

FIG. 1 shows a paint booth of a surface finishing system, with a first exemplary embodiment of an overspray deposition apparatus, in a front view;

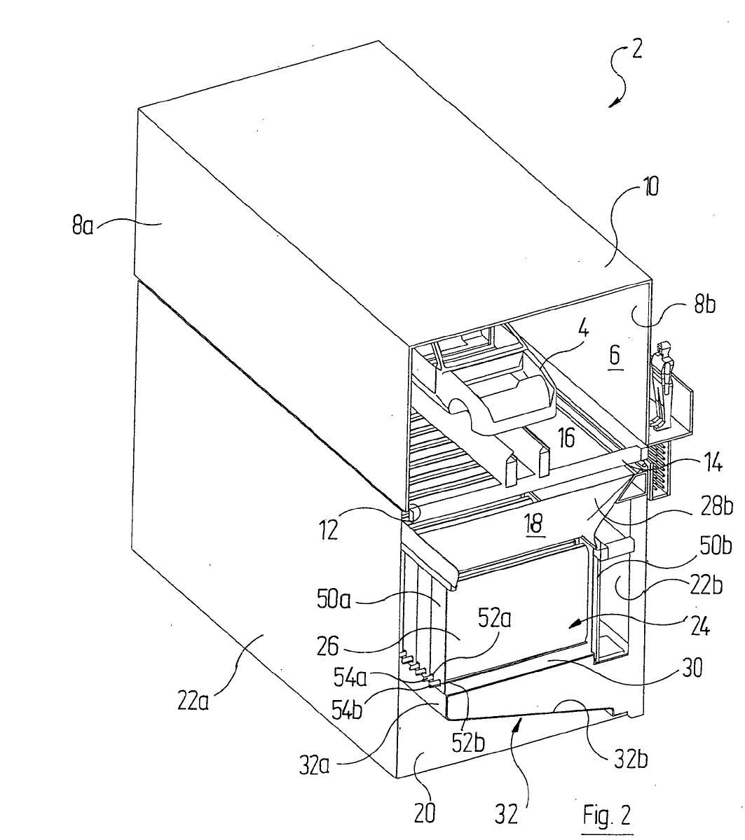

FIG. 2 shows the paint booth from FIG. 1, in a perspective view;

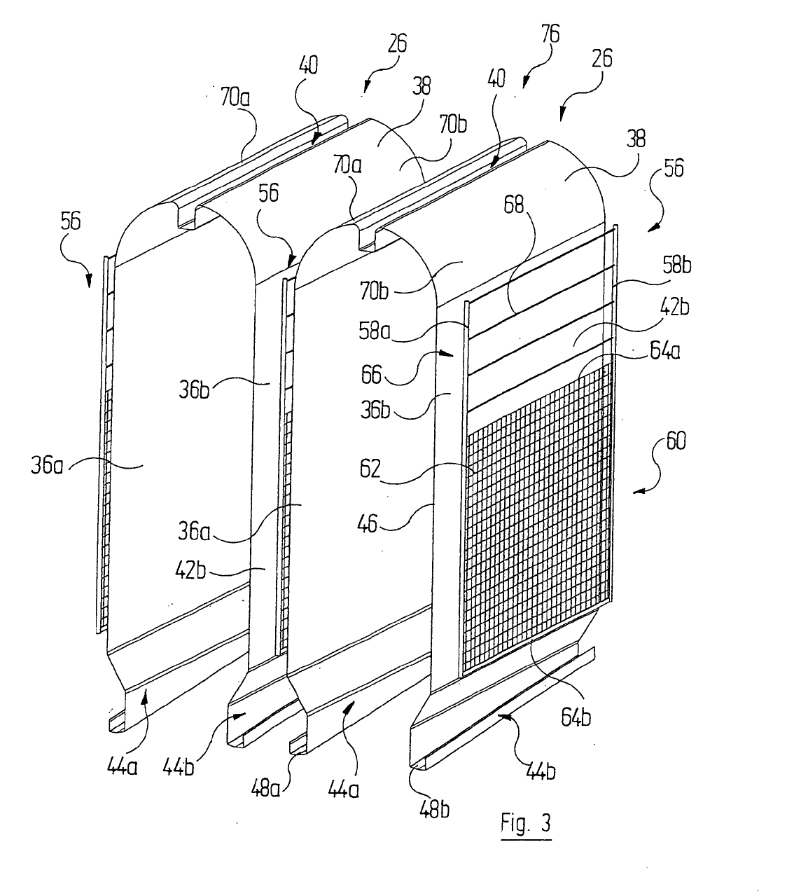

FIG. 3 shows a perspective view of two separation units and three electrode means of the deposition apparatus from FIG. 1;

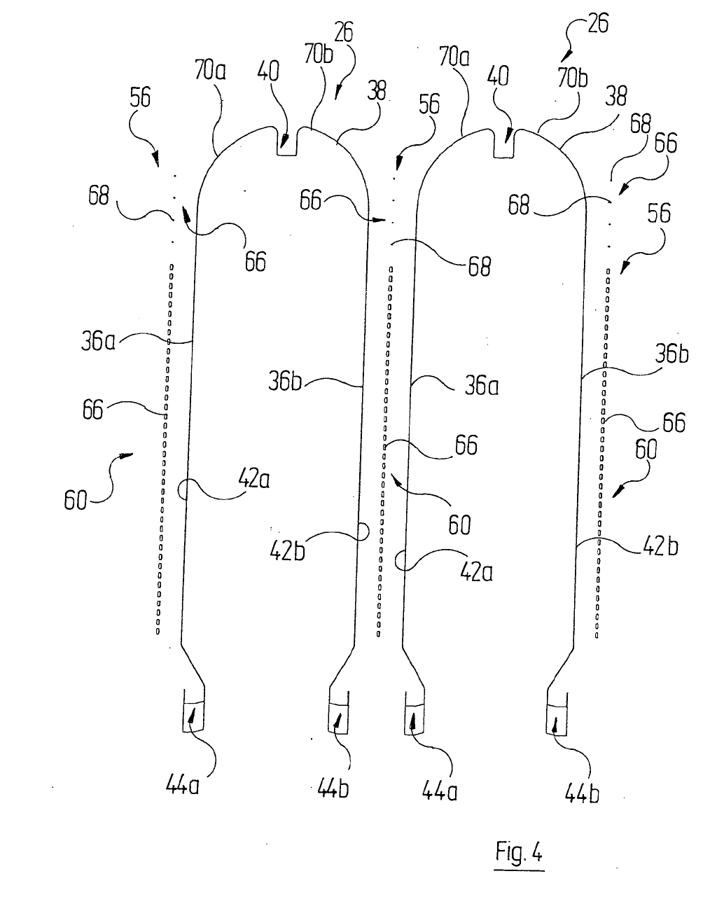

FIG. 4 shows the two separation units with electrode means from FIG. 3, in vertical section;

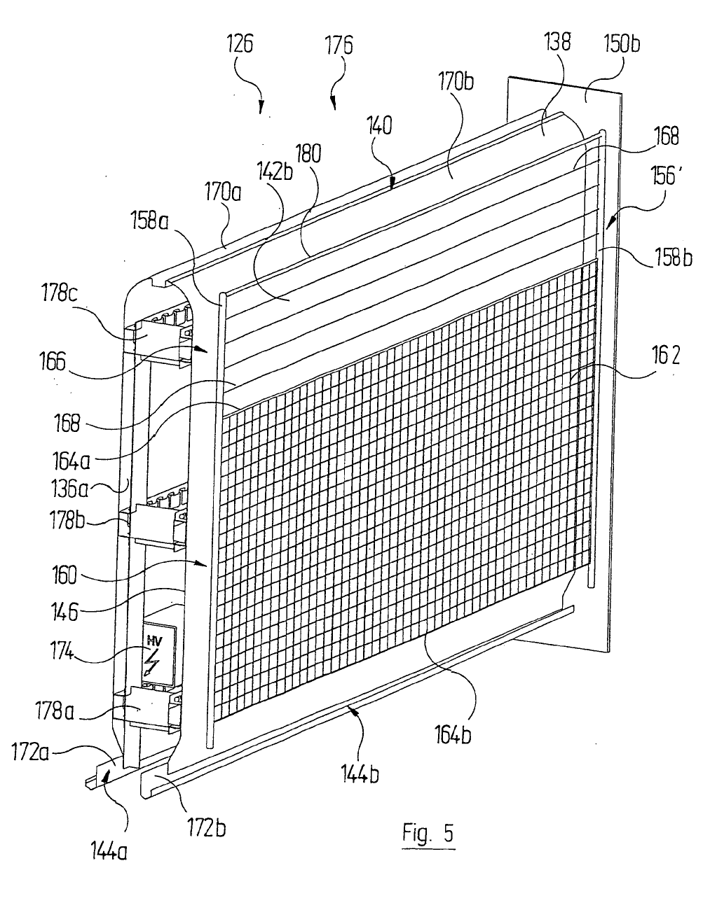

FIG. 5 shows a perspective view of two separation units and three electrode means, in each case according to a second exemplary embodiment;

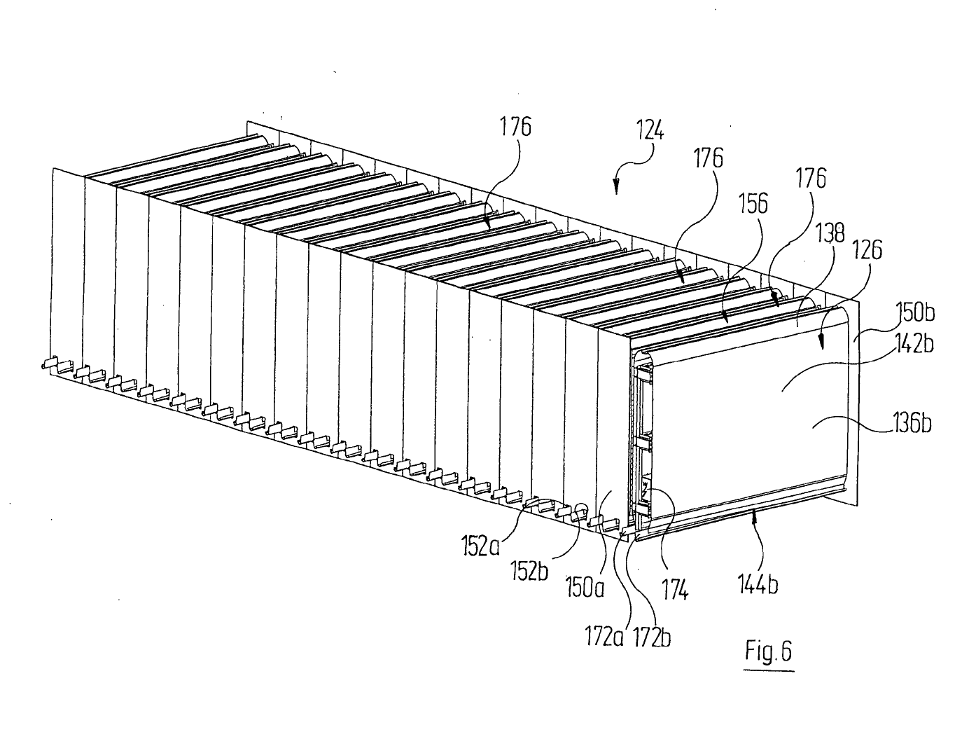

FIG. 6 shows a perspective view of a second exemplary embodiment of an overspray deposition apparatus which comprises a plurality of separation units and electrode means from FIG. 5;

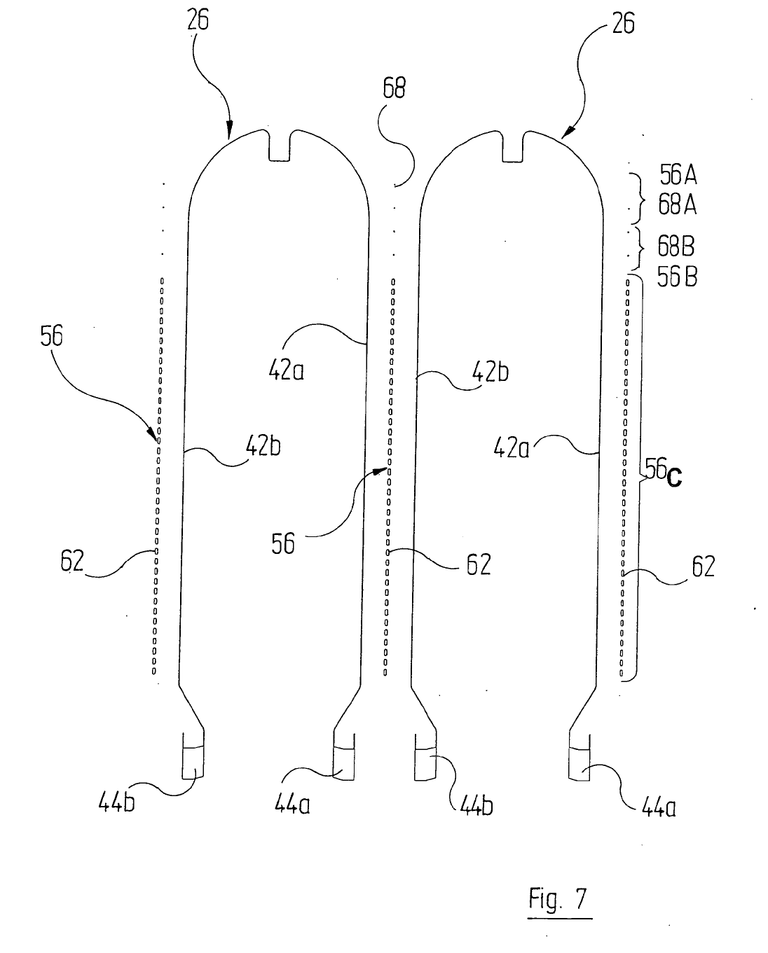

FIG. 7 shows schematically the subdivision of the electrode means of FIG. 3 into a plurality of regions which may be charged with high voltage independently of one another.

Reference is first of all made to FIGS. 1 and 2. Here, 2 designates as a whole a paint booth of a surface finishing system in which vehicle bodies 4 are painted, after they have been cleaned and degreased, for example, in pre-treatment stations which are upstream of the paint booth 2 and are not specifically shown.

The paint booth 2 comprises a painting tunnel 6 which is arranged at the top and is delimited by vertical side walls 8a, 8b and a horizontal booth ceiling 10 but which at the end sides and downwards is open such that used booth air which is laden with overspray can flow downwards. The booth ceiling 10 is configured with a filter ceiling, in the conventional manner, as the lower delimitation of the air supply chamber (not illustrated).

Arranged at the level of the lower opening 12 of the painting tunnel 6, which is flanked by the lower edges of the side walls 8a, 8b, is a steel structure 14 which carries a conveyor system 16 which is known per se and which is not described in more detail here. This can be used to transport vehicle bodies 4 that are to be painted from the entry side of the painting tunnel 6 to the exit side thereof. Inside the painting tunnel 6 there are application means which are not specifically shown and which can be used to apply paint to the vehicle bodies 4 in a manner known per se.

Below the lower opening 12 of the painting tunnel 6 there is a separation chamber 18 which is upwardly open, towards the painting tunnel 6, and in which paint overspray which arises during the painting procedure is separated off.

The separation chamber 18 is delimited by a base plate 20 which is visible in FIG. 2, two vertical side walls 22a, 22b and two vertical end walls, said two vertical end walls being omitted from FIGS. 1 and 2.

Arranged in the separation chamber 18 is a deposition apparatus 24 having a plurality of separation units 26 which are arranged one behind the other in the longitudinal direction of the separation chamber 18 and which are described in more detail below.

In the region of the separation chamber 18 between the deposition apparatus 24 and the painting tunnel 6 there are two air baffles 28a, 28b which, starting from the side walls 22a, 22b of the separation chamber 18, first converge downwards and, in their end region facing the deposition apparatus 24, diverge towards the lateral delimitations of the deposition apparatus 24. The air baffles 28a, 28b and corresponding air baffles, not illustrated, at the end sides extend downwards as far as the deposition apparatus 24.

The separation units 26 rest on a carrying frame 30 which allows air to flow downwards out of the deposition apparatus 24. Below the deposition apparatus 24 there is a further air baffle 32 which extends along the deposition apparatus 24 in the separation chamber 18. The air baffle 32 has a vertical section 32a which faces the left side wall 22a of the separation chamber 18, in FIGS. 1 and 2, and a section 32b which runs obliquely downwards in the direction of the opposing side wall 22b of the separation chamber 18.

Between the vertical section 32a of the air baffle 32 and the left side wall 22a of the separation chamber 18, in FIGS. 1 and 2, there is arranged a collecting channel 34, shown only schematically in FIG. 1, which extends parallel to the vertical section 32a of the air baffle 32 and which is inclined in the longitudinal direction in relation to a horizontal plane.

FIGS. 3 and 4 show two adjacent separation units 26 of the deposition apparatus 24. As can be seen there, a separation unit 26 comprises two parallel, mutually spaced-apart, rectangular side panels 36a, 36b which are connected to one another at their upper opposing end edges by a curved section 38, the cross section of the internal shape of the outer contour thereof corresponding to a semicircle and forming the upper side of the separation unit 26.

At its apex, the curved section 38 of the separation units 26 is constructed to have the form of an overflow channel 40, about which more details are given below.

The respective outer surfaces of the side panels 36a, 36b form separation surfaces 42a and/or 42b, about which, again, more details are given below.

At their lower edges, the side panels 36a, 36b each carry a drainage channel 44a, 44b which runs parallel to the side panels 36a, 36b of the separation units 26 and is inclined downwards in the direction of a first end side 46 of the separation unit 26, at the front in FIG. 3. The drainage channels 44a, 44b terminate at their end sides with the side panels 36a, 36b of the separation unit 26 (cf. FIG. 3). At their end 48a and/or 48b, the drainage channels 44a, 44b are open at the first end side 46 (cf. FIG. 3) of the separation unit 26.

As can be seen in FIGS. 1 and 2, each separation unit 26 comprises a first end wall 50a which is arranged on the first end side 46 thereof. The opposing end side of the separation units 26, which is not provided with its own reference numeral, is covered by a second end wall 50b. The end walls 50a, 50b of the separation units 26 close off the end sides of the associated overflow channel 40. The two end walls 50a, 50b are made from synthetic material. The first end wall 50a of the separation unit 26 comprises two apertures 52a, 52b into which one respective drainage channel 44a, 44b opens at its ends 48a, 48b. On the side of each end wall 50a opposed to the drainage channels 44a, 44b, drip trays 54a, 54b are mounted at the apertures 52a, 52b. Said drip trays take the form of profiled sections, the cross section thereof corresponding to that of the drainage channels 44a, 44b.

When the deposition apparatus 24 is arranged in the separation chamber 18 of the paint booth 2, the drip trays 54a, 54b of each separation unit 26 project beyond the collecting channel 34.

In the deposition apparatus 24, each pair of adjacent separation units 26 is arranged with a spacing maintained therebetween. Between two adjacent separation units 26 and, in the case of the free side panels 36a and/or 36b of the two outermost separation units 26, within the deposition apparatus 24 there extends one respective electrode means 56.

Each electrode means 56 comprises two straight electrode strips 58a, 58b extending parallel to one another. Said electrode strips hold a planar electrode 62, in the example in the form of a grid electrode, in a field section 60 of the electrode means 56, the edges 64a, 64b of said grid electrode which extend between the electrode strips 58a, 58b being perpendicular thereto. In a corona section 66 of the electrode means 56, the electrode strips 58a, 58b hold a plurality of corona wires 68 which function as a discharge electrode. The corona wires 68 run in a plane predetermined by the electrode strips 58a, 58b, parallel to the edges 64a, 64b of the grid electrode 62, and are arranged at the same spacing from one another.

As can be seen in FIGS. 3 and 4, the overall extent of the electrode means 56 corresponds substantially to the extent of the side panels 36a, 36b of the separation units 26. The electrode means 56 are arranged such that the lower edge 64b of the grid electrode 62 is arranged approximately at the level of the lower end of the side panels 36a and/or 36b.

When the deposition apparatus 24 is in operation, a separating liquid, which is capable of taking up solid particles from the paint overspray arising during the painting procedure, flows down each separation surface 42a, 42b of the side panels 36a, 36b of the separation units 26, into the drainage channels 44a, 44b.

For this purpose, this separating liquid is supplied to the overflow channel 40 in the curved section 38 of the separation units 26. From there the separating liquid passes over the curved flanks 70a, 70b of the curved section 38 of the separation unit 26, which run next to the overflow channel 40, in each case as a cohesive film, to reach the side panels 36a, 36b and flows down the separation surfaces 42a, 42b thereof as a still cohesive film of separating liquid.

The number of corona wires 68 of the electrode means 56, and their spacing from one another, may vary as a function of the separation behaviour of the overspray particles. In the present exemplary embodiment, four corona wires 68 are provided, of which the uppermost is arranged next to the curved section 38 of the separation unit 26, whereas the corona wire 68 therebelow is still in the region adjacent to the respective side panel 36a and/or 36b of the separation unit 26.

As, in particular, may be derived from FIG. 7, the four corona wires 68 are subdivided into two groups 68A, 68B. They are connected electrically in parallel within these groups 68A, 68B and thus form a “region” 56A and/or 56B of the electrode means 56. Each of these regions 56A, 56B may be connected to a high voltage source 74 via a suitable switching device, for example, via high voltage contactors. The switching device and the high voltage source are not shown in the drawings of this exemplary embodiment. The planar grid electrode 62 is also charged by a separate high voltage source 74.

The various regions 56A, 56B and 56C of the electrode means 56 are charged with high voltage in a cyclical manner, for example so that initially the uppermost region 56A, then the region 56B following said uppermost region and then the following region 56C produced by the grid electrode, are connected to the respective high voltage source 74. Thus only one of the three regions 56A, 56B, 56C is at high voltage. This cyclical charging with high voltage is sufficient to achieve the desired ionisation in the region of the corona wires 68 and the separation in the region of the grid electrode 62; however, relative to continuous charging with high voltage, this is associated with energy saving. Additionally, the risk is reduced of overspray particles being already separated off in the region of the separation units 26 opposing the corona wires 68, where this is less desirable.

FIG. 5 shows, in each case as a second exemplary embodiment, a modified separation unit 126 and a modified electrode means 156, and FIG. 6 shows a modified deposition apparatus 124 comprising said elements. Components of the separation unit 126, the electrode means 156 and the deposition apparatus 124 that correspond to those of the separation unit 26, the electrode means 56 and the deposition apparatus 24 in FIGS. 1 to 4 are designated by the same reference numerals plus 100.

The separation unit 126 differs from the separation unit 26, amongst other things, in that the drainage channels 144a, 144b project beyond the end side 146 of the separation unit 126. The projecting sections 172a, 172b correspond to the drip trays 54a, 54b described above, and for this reason they need not be described in connection with the deposition apparatus 124.

As can be seen in FIG. 6, the projecting sections 172a, 172b of the drainage channels 144a, 144b of the separation unit 126 extend through the respective apertures 152a, 152b in each end wall 150a of the deposition apparatus 124.

FIG. 5 shows one of a plurality of high-voltage sources 174 which is arranged between the side panels 136a, 136b of each separation unit 126 and in each case is connected to one of the regions 156A, 156B, 156C of the electrode means 156. High-voltage sources 174 may also, correspondingly, be present for each separation unit 26 according to the first exemplary embodiment. In each case, an individual separation unit 126 and an individual electrode means 156 in this manner form a separation module 176. Accordingly, an individual separation unit 26 and an individual electrode means 56 in each case also form a separation module 76 in FIGS. 1 to 4.

In FIG. 5, struts 178a, 178b, 178c are also visible, which connect to one another the inner faces of the two side panels 136a, 136b of the separation unit 126 at the bottom, in the centre and at the top.

In the case of the electrode means 156 according to the second exemplary embodiment, a protective bar 180 runs perpendicularly between the electrode strips 158a, 158b above the uppermost corona wire 168 and reduces the risk of objects or particles which may fall out of the painting tunnel 6 and onto the electrode means 156 coming into contact with the corona wires 168.

Otherwise, what was said above in relation to the separation unit 26, the electrode means 56 and the deposition apparatus 24 also applies correspondingly to the separation unit 126, the electrode means 156 and the deposition apparatus 124.

The basic principle of the devices described above is now explained by way of the example of the deposition apparatus 24 according to FIGS. 1 to 4. The deposition apparatus 124 according to FIGS. 5 and 6 is used in the paint booth 2 in similar manner.

When the vehicle bodies are painted in the painting tunnel 6, the booth air there is laden with particles of paint overspray. Said particles may still be liquid and/or tacky, but may also already be more or less solid. The used booth air which is laden with paint overspray flows through the lower opening 12 of the painting tunnel 6 and into the separation chamber 18. There, this air is deflected by the air baffles 28a, 28b in the direction of the deposition apparatus 24 and flows through between adjacent separation units 26 in the direction of the lower air baffle 32.

Corona discharges occur at the corona wires 68 in a manner known per se, and said discharges effectively ionise the overspray particles in the used booth air which flows past.

The ionised overspray particles move past the earthed side panels 36a, 36b of two adjacent separation units 26 and the grid electrode 62 extending therebetween. Because of the electrical field formed between the grid electrode 62 and the side panels 32a, 32b, the ionised overspray particles are separated at the separation surfaces 42a, 42b of the separation units 26 and are taken up there by the separating liquid flowing along said surfaces.

Some of the ionised overspray particles are already separated off on the separation units 26 in the region of the corona wires 68. The electrical field present between the corona wires 68 and the respective side panel 36a, 36b of the separation unit 26 is more inhomogeneous than the electrical field in the region of the grid electrode 62, however, and for this reason separation of the ionised overspray particles on the corresponding separation unit 26 is more directed and more effective there.

The air which is cleaned as it passes between the separation units 26 is deflected, by the lower air baffle 32, in the direction of the side wall 22b of the separation chamber 18, shown on the right in FIGS. 1 and 2, and from there it can be supplied to the painting tunnel 6 again as fresh air, where appropriate, after undergoing certain treatment. The treatment may, in particular, be a readjustment of the temperature, the air humidity and, where appropriate, the removal of solvents that are still present in the air.

The separating liquid which flows down over the separation units 26 and is now laden with the overspray particles passes down into the drainage channels 44a, 44b of the separation units 26. As a result of the inclination of the drainage channels 44a, 44b, the laden separating liquid flows in the direction of the apertures 52a, 52b in the respective end walls 50a, through these and from there via the drip trays 54a, 54b into the collecting channel 34. The separating liquid laden with overspray particles flows through the collecting channel 34 and out of the paint booth 2 and may be transported for cleaning and reprocessing, in which the overspray particles are removed from the separating liquid, or for disposal.

1. An apparatus for deposition of lacquer overspray from the used booth air of painting facilities laden with overspray, comprising
a) at least one separation surface, along which booth air can be guided and which is connected in an electrically conductive manner to a pole of a high voltage source;
b) at least one electrode means arranged in the booth air, which is associated with the separation surface and which may be connected to another pole of the high voltage source;
wherein
c) a plurality of electrode means and/or a plurality of regions of electrode means allocated to different separation surfaces are provided, which may be charged with high voltage independently of each other.

2. The device of claim 1, wherein the plurality of electrode means and/or the plurality of regions of electrode means may be connected to the same high voltage source.

3. The device of claim 1, wherein a separate high voltage source is assigned to each of the plurality of electrode means and/or each of the plurality of regions of electrode means.

4. The device of claim 1, wherein the at least one electrode means comprises a plurality of corona wires and a planar field electrode as regions able to be charged independently with high voltage.

5. The device of claim 4, wherein the plurality of corona wires are subdivided into a plurality of groups, each group being a region of the electrode means which may be charged independently with high voltage.

6. The device of claim 2, wherein the at least one electrode means comprises a plurality of corona wires and a planar field electrode as regions able to be charged independently with high voltage.

7. The device of claim 3, wherein the at least one electrode means comprises a plurality of corona wires and a planar field electrode as regions able to be charged independently with high voltage.
